(19) United States
(12) Patent Application Publication
(10) Pub. No.: US 2022/0173408 A1
(43) Pub. Date: Jun. 2, 2022

(54) SOLID OXIDE FUEL CELL WITH SCANDIUM-MODIFIED NICKEL FELT ANODE COLLECTOR

(71) Applicant: Ariel University of Samaria, Ariel (IL)

(72) Inventors: Manasa Kumar RATH, Ariel (IL); Alexey KOSSENKO, Ashdod (IL); Alexander KRASNOPOLSKI, Petah Tikva (IL); Michael ZINIGRAD, Ramat-Gan (IL)

(21) Appl. No.: 17/432,220

(22) PCT Filed: Sep. 8, 2019
(86) PCT No.: PCT/IL2019/051002

§ 371 Date: Aug. 19, 2021

Related U.S. Application Data
(60) Provisional application No. 62/807,785, filed on Feb. 20, 2019.

(51) Int. Cl. H01M 4/86; H01M 4/90; H01M 8/1231; H01M 4/88

(52) U.S. Cl. CPC H01M 4/8621; H01M 4/9033; H01M 4/9066; H01M 8/1231; H01M 2008/1293; H01M 4/8885; H01M 4/886; H01M 2300/0077; H01M 4/8835

(57) ABSTRACT

A solid oxide fuel cell (SOFC) assembly connectable to a source of a hydrocarbon fuel; said SOFC assembly comprises at least one SOFC. Each SOFC further comprises: (a) an anode support member having a nickel felt-made anode current collector; (b) an electrolyte layer disposed on the anode support member; and a cathode having a cathode current collector; the cathode disposed on said electrolyte layer. The nickel felt-made anode current collector is doped with Scandium.

### FIELD OF THE INVENTION

The present invention relates to a solid oxide fuel cell (SOFC) and, more particularly, to a SOFC with a scandium-doped nickel felt anode collector.

### BACKGROUND OF THE INVENTION

Solid oxide fuel cells (SOFCs) are electrochemical energy conversion device which converts various fuels based on hydrocarbons (natural gas, LPG) into electricity and heat with an unparalleled fuel-to-electric conversion efficiency among other types of fuel cells (Stambouli, A, et al. “Solid oxide fuel cells (SOFCs): a review of an environmentally clean and efficient source of energy.” Renewable and sustainable energy reviews 6.5 (2002): 433-455; Wang, Wei, et al. “Progress in solid oxide fuel cells with nickel-based anodes operating on methane and related fuels.” Chemical reviews 113.10 (2013): 8104-8151). One of the key barriers to widespread deployment of the SOFC has been its high cost associated with its high temperature of operation, typically in the 800-1000° C. This high operating temperature enables fuel flexibility (Eguchi, K., et al. “Fuel flexibility in power generation by solid oxide fuel cells.” Solid State Ionics 152 (2002): 411-416). However, this high operating temperature tends to use of expensive sealant and precious metals current collection for cell operation. During cell operation, hydrogen oxidation reaction (HOR) occurred at the interface of the anode-electrolyte following to the oxygen reduction reaction (ORR) at the cathode, where the current measurement must be carried out in this high operating temperature with a wide range of partial pressure ranging p(O)₂ 10⁻¹⁵˜10⁻¹ bar (Atkinson, A. et al. (2011). Advanced anodes for high-temperature fuel cells. In Materials For Sustainable Energy: A Collection of Peer-Reviewed Research and Review Articles from Nature Publishing Group (pp. 213-223).

Therefore specific material having high electronic conductivity; chemically inert; compatible thermal expansion; as the current collectors are required for reliable operation of SOFC (Guillodo, M. et al. “Electrochemical properties of Ni—YSZ cermet in solid oxide fuel cells: effect of current collecting.” Solid State Ionics 127.1-2 (2000): 99-107; Steele, B. C., & Heinzel, A. (2011). Materials for fuel-cell technologies. In Materials For Sustainable Energy: A Collection of Peer-Reviewed Research and Review Articles from Nature Publishing Group (pp. 224-231); Deleebeeck, Lisa, and Kent Kammer Hansen. “Hybrid direct carbon fuel cell performance with anode current collector material.” Journal of Electrochemical Energy Conversion and Storage 12.6 (2015): 064501). The essential prerequisite for the consistent operation of the cell must have a stable current collector with good contact with the electrode over a prolonged period of operation, furthermore, in an anode, the current collector must have the potential to withstand the robust condition low partial pressure of oxygen, coking, and sulfur poisoning (Flesch, U., et al. “Properties of nickel mesh as a methane steam reforming catalyst and its application in SOFCs.” ECS Proceedings, Volumes 1999 (1999): 612-620) Generally, in lab scale, small button cell the precious metal (Pt_{;} Au, and Ag) as the current collector are often be used as anode current collector, these metals act as good current collectors (Liu, Meilin, et al. “Rational SOFC material design: new advances and tools.” Materials Today 14.11 (2011): 534-546; Sengodan, Sivaprakash, et al. “Layered oxygen-deficient double perovskite as an efficient and stable anode for direct hydrocarbon solid oxide fuel cells.” Nature materials 14.2 (2015): 205) However, the high cost of the precious metals current collector is a major hurdle for commercialization (Hiraiwa, Chihiro, et al. “Application of Ni Porous Metal to Solid Oxide Fuel Cells.” Sei Technical Review 83 (2016): 59).

Interestingly current collector is exhibiting catalytic activity depending on the choice of materials and configuration. The catalytic activity of the current collector not only that improve the performance but also the durability of the cell. In these aspects, many research is reported previously (Casarin, Michele, and Vincenzo M. Sglavo. “Effect of the Current Collector on Performance of Anode-Supported Microtubular Solid Oxide Fuel Cells.” Journal of Fuel Cell Science and Technology 12.3 (2015): 031005; Jiang, S. P. et al. “Effect of contact between the electrode and current collector on the performance of solid oxide fuel cells.” Solid State Ionics 160.1-2 (2003): 15-26; Li, Tao et al. “A dual-structured anode/Ni-mesh current collector hollow fiber for micro-tubular solid oxide fuel cells (SOFCs).” Journal of Power Sources 251 (2014): 145-151; Cantos-Gómez, A. et al. “Ag as an alternative for Ni in direct hydrocarbon SOFC anodes.” Fuel Cells 11.1 (2011): 140-143; Canavar, Murat, and Yuksel Kaplan.

“Effects of mesh and interconnector design on solid oxide fuel cell performance.” International Journal of Hydrogen Energy 40.24 (2015): 7829-7834. Keeping the main objective as an efficient and reliable operation under hydrocarbon fuel with reasonable cost, the development of an alternative collector other than precious metals is great importance for practical deployment of SOFC. The Ni-current collectors (Ni-foam, Ni-fiber felt, Ni-mesh) and stainless steel are more suitable in these aspects, as they are stable under the anodic condition and compatible with the state-of-the-art nickel cermet anodes (Weber, A., Sauer, B., Muller, A. C., Herbstritt, D., & Ivers-Tiffee, E. (2002). Oxidation of H2, CO and methane in SOFCs with Ni/YSZ-cermet anodes. Solid State Ionics, 152, 543-550). Specifically, the Ni-foam based current collector is exceptional quality, because these are cost-effective, and exhibits high electronic conductivity, substantial catalytic activity compared to the precious metal current collector, the polarization resistance value for HOR activity of the most common current collector are in the order: Ni<Pt<Au. However, the palladium (Pd) as current collector exhibits higher cell performance than the Ni— current collector due to the higher catalytic activity for hydrogen oxidation. Flesch et al. reported the effect of the pre-oxidized nickel mesh current collector followed by reduction on the Ni—YSZ anode supported SOFC, resulting in high catalytic activity for methane steam reforming thus the performance of the cell improved compared to the untreated Ni-foam current collector. While, Hiraiwa et al., studied alloying the nickel (Ni) with tin (Sn) to form a porous Ni—Sn current collector for the SOFC stacks, This Ni—Sn exhibits high thermal oxidation resistance and gas diffusion performance which resulting in high power density equivalent to the Pt-mesh current collector.

The internal reforming of carbon-containing fuels over nickel-based cermet anode promotes carbonaceous deposit on the surface and inside the anode microstructure. These issues of the coking and carbon deposition blocked the active reaction sites resulting degradation of the cell performance and breakdown of the cell (Park, Seungdoo, John M. Vohs, and Raymond J. Gorte. “Direct oxidation of hydrocarbons in a solid-oxide fuel cell.” Nature 404.6775 (2000): 265).

Many innovative strategies have been devised to respond the above drawbacks, such as by increasing the S/C (steam to carbon ratio) contents in the fuel, using CeO₂ and Ni—Cu or Ni—Co alloy in the cermet, or replaced the nickel-cermet with perovskite anode. However, this practice leads to a loss of the performance and efficiency of compared to the Ni-based cermet (Lanzini, A. et al. (2013). The durability of anode supported Solid Oxides Fuel Cells (SOFC) under direct dry-reforming of methane. Chemical engineering journal, 220, 254-263; Kishimoto, H. et al. (2007). Stability of Ni-based anode for direct hydrocarbon SOFCs. Journal of Chemical Engineering of Japan, 40(13), 1178-1182; Xiao, J. et al. (2014). Deactivation of the nickel-based anode in solid oxide fuel cells operated on carbon-containing fuels. Journal of Power Sources, 268, 508-516; Iida, T. et al. (2007). Internal refoi filing of SOFCs carbon deposition on fuel electrode and subsequent deterioration of cell. Journal of the !Electrochemical Society, 154(2), B234-B241).

U.S. Pat. No. 8,455,154 discloses a solid oxide fuel cell (SOFC) including a plurality of subassemblies. Each subassembly includes at least one subcell of a first electrode, a second electrode and an electrolyte between the first and second electrodes. A first bonding layer is at the second electrode, and an interconnect layer is at the first bonding layer distal to the electrolyte. A second bonding layer that is compositionally distinct from the first bonding layer is at the interconnect layer, whereby the interconnect partitions the first and second bonding layers. A method of fabricating a fuel cell assembly includes co-firing at least two subassemblies using a third bonding layer that is microstructurally or compositionally distinct from the second bonding layer.

The electrochemical test in humidified methane under potentiostatic condition reveals that the ohmic and polarization resistance are lessened with cell operation time along with degradation observed in the cell with the nickel-felt current collector. There is a long-felt and unmet need to provide a current collector demonstrating improved stability.

### SUMMARY OF THE INVENTION

It is hence one object of the invention to disclose a solid oxide fuel cell (SOFC) assembly connectable to a source of a hydrocarbon fuel; the SOFC assembly comprising at least one SOFC; each SOFC further comprising: (a) an anode support member having a nickel felt-made anode current collector; (b) an electrolyte layer disposed on the anode support member; and (c) a cathode having a cathode current collector; the cathode disposed on the electrolyte layer.

It is a core purpose of the invention to provide the nickel felt-made anode current collector doped with scandium.

Another object of the invention is to disclose the cathode, anode, and electrolyte which are nested within a ceramic bond.

A further object of the invention is to disclose the cathode made of a LSM/ScSZ composite material.

A further object of the invention is to disclose the anode support member made of sintered Ni—ScSZ.

A further object of the invention is to disclose the electrolyte layer which is a ScSZ paste.

A further object of the invention is to disclose the felt-made anode current collector doped with scandium made by spraying solution of Sc₂O₃ in HNO₃.

A further object of the invention is to disclose a method of manufacturing a solid oxide fuel cell; the method comprising steps of: (a) manufacturing an anode support member by sintering NiO and ScSZ; (b) spraying an electrolyte ScSZ layer on the anode support member; (c) sintering the electrolyte ScSZ layer; (d) printing a cathode layer of LSM-ScSZ paste on the electrolyte ScSZ layer; (e) sintering the cathode layer; (f) manufacturing anode and cathode current collectors; and (g) connecting the anode and cathode current collectors to the anode and cathode, respectively.

It is a core purpose of the invention to provide the step of manufacturing anode and cathode current collectors comprising manufacturing the anode current collector by spraying solution of Sc₂O₃ in HNO₃ onto a nickel felt.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of an anode supported solid oxide fuel cell (SOFC);

FIG. 2 is a graph of power density and cell voltage (hollow symbols) as a function of current density in humidified CH₄ for a Ni—ScSZ anode-supported SOFC with Ni-felt and Sc:Ni felt current collector at 700° C.;

FIG. 3 is a graph of the galvanostatic test of an anode supported SOFC applying a current density j=0.2 A cm⁻² at 700° C. for the P-cell (Ni-mesh) and S-cell (Sc: Ni-mesh) in humidified CH₄ at 700° C. for 1 h;

FIGS. 4a and 4b are graphs of impedance spectra of Ni—ScSZ supported cell; (a) Ni-felt, (b) Sc: Ni-felt current collection;

FIG. 5 shows XRD patterns after the electrochemical characterization in CH₄ at 700° C. of the P-cell (a) current collector, (b) anode, and of S-cell (c) current collector, (d) anode;

FIGS. 6a and 6b are SEM images of the anode microstructure (a) P-cell, and (b) S-cell after the electrochemical characterization in CH₄ at 700° C.;

FIG. 7a is a cross-sectional SEM image of as-fabricated SOFC with configuration the Ni—ScSZ/AFL|ScSZ|LSM-SsSZ cell with EDXA mapping

FIG. 7b is a cross-sectional SEM image of a full cell;

FIG. 7b is a cross-sectional SEM image of a full cell;

FIGS. 7c to 7h are cross-sectional SEM images doped with Zr (c); O (d); Ni (e); La (f); Sc (g); and Mn (h);

FIGS. 7c to 7h are photographs of (a) as received Ni-felt, (d) 1 wt % scandium coated Ni-felt (Sc:Ni-Felt), following exposure to humidified CH₄ at 700° C. for 5 h, (b) Ni-felt, and (e) Sc:Ni-felt, and following electrochemical testing of cell (c) Ni-felt, and (f) Sc:Ni-felt;

FIGS. 8a to 8c are SEM images of (a) as received Ni-felt, (b) Ni-felt, and (c) Sc:Ni-felt exposure to humidified CH₄ at 700° C.

### DETAILED DESCRIPTION OF THE INVENTION

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide an anode supported solid oxide fuel cell and a method manufacturing the same.

Scandium modified Ni-fiber felt as the anode current collector for a hydrocarbon fuel (CH₄) SOFC by using the. Nickel is an effective catalyst used for oxidation and cracking of the hydrocarbon (Dissanayake, Dhammike, et al. “Partial oxidation of methane to carbon monoxide and hydrogen over a Ni/Al2O3 catalyst.” Journal of Catalysis 132.1 (1991): 117-127; Amin, A. M. et al. (2012). Hydrogen production by methane cracking using Ni-supported catalysts in a fluidized bed. International journal of hydrogen energy, 37(14), 10690-10701; Choudhary, T. V. et al. (2001). Hydrogen production via catalytic decomposition of methane. Journal of catalysis, 199(1), 9-18; Yamaji, Katsuhiko, et al. “Feasibility of Ni-based cermet anode for direct HC SOFCs: Fueling ethane at a low S/C condition to Ni—ScSZ anode-supported cell.” Journal of power sources 159.2 (2006): 885-890) Meanwhile, the scandium exhibits considerable catalytic activity for methane conversions and methane selectivities (Fokema, M. D., & Ying, J. Y. (1998). The selective catalytic reduction of nitric oxide with methane over scandium oxide, yttrium oxide, and lanthanum oxide. Applied Catalysis B: Environmental, 18(1-2), 71-77; Catalytic Functionalization of Hydrocarbons by s-Bond-Metathesis Chemistry: Dehydrosilylation of Methane with a Scandium Catalyst, Aaron D. Sadow T. Don Tilley Prof, Angew. Chem. Int. Ed. 2003, 42, No. 7, 803-805). It is expected that the scandium modified Ni-mesh improved the partial oxidation of methane resulting limitation of the carbon formation on the anode, enhance the efficiency and durability.

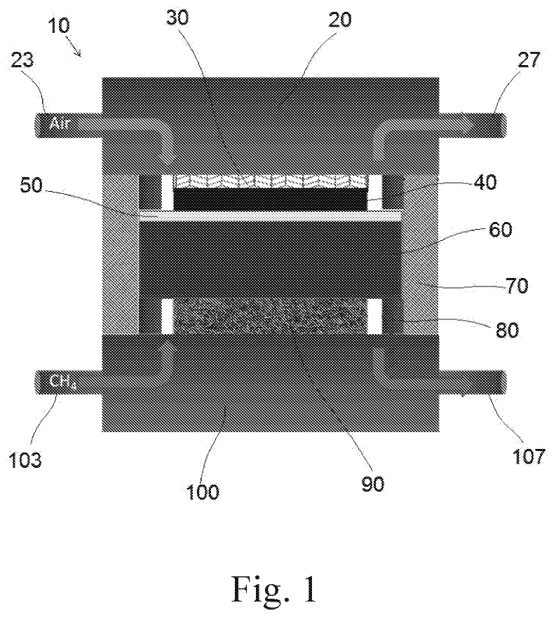

Reference is now made to FIG. 1 presenting a schematic diagram of anode supported solid oxide fuel cell (SOFC) 10. The aforesaid SOFC comprises cathode chamber 20 and anode chamber 100. Cathode chamber 10 is provided with inlet port 23 fed with moist air and exhaust port 27. Anode chamber 100 has inlet port 103 fed with a hydrocarbon fuel, for example, methane CH₄, and exhaust port 107. Ceramic bond 70 embraces electric elements of SOFC 10. Specifically, numeral 60 refers to a Ni—ScSZ sintered anode made of support carrying a layer 50 of ScSZ electrolyte and LSM-ScSZ cathode 40 successively sintered on anode support 60. Cathode current collector 30 is in electric contact with cathode 40 while anode current collector 90 with anode 60. It should be appreciated that anode current collector is formed by spraying nickel-fiber felt modified by scandium. The solution of Sc₂O₃ in HNO₃ is sprayed onto a nickel felt.

### Example 1

### Fabrication of the Anode-Supported SOFC

The slurry composition of the NiO—ScSZ anode support layer is shown in Table-1. At first, the NiO and ScSZ powder and pore-former (cornstarch) are ball-milled in the azeotropic mixture of ethanol-MEK (2-butanone) with dispersant triethanolamine (TEA) for 24 h using zirconia ball (4 mm). After homogenization of the powders in the solvent system, the primary plasticizer Dibutyl phthalate (DBP) and secondary plasticizer polyethylene glycol (PEG-400) were mixed to the slurry and milled for 6 h, finally, the binder polyvinyl butyral (PVB) is mixed into the slurry and further milled for 48 h. The slurry is de-aired in a polycarbonate vacuum desiccators (Sanplatec) applying the vacuum of 100 psi for 2 h. The viscosity of the slurry then measured by Brookfield LV viscometer (model—MLVT115) using Spindle-LV4. The measured viscosity of the slurry was 8550 and 6730 cps at 20 rpm and 50 rpm, respectively, at room temperature. The slurry then tape cast on a silicon-coated Mylar film (Tape casting warehouse, inc.) by MTI automatic thick film coater (Model—MSK-AFA-III) and doctor blade (Micrometer Adjustable Film Applicator −100 mm). The green film thickness was maintained to 1.5 mm which was dried at room temperature overnight.

The green tape-shaped to 6.4×6.4 cm² and sintered at multiple steps for binder burn out with a ramp 0.5° C. min⁻¹, finally pre-sintered at 1200° C. for 4 h. The pre-sintered anode support was then polished by sandpaper, the anode functional layer is sprayed onto the anode support followed by drying and binder burn out at 400° C. for 2 h. Finally the electrolyte (10ScSZ) slurry was spray coated onto the AFL layer. After drying the electrolyte layer the half-cell was sintered at 1400° C. for 4 h. Composite cathode paste LSM-ScSZ (50:50 wt. %) was prepared by mixing the LSM powder (LSM-20 HP, Fuel cell materials, SSA=11.8 m² /g), 10Sc1CeSZ (ScCeSZ-TC, Fuel cell materials, SSA=10.6 m²/g) with ink vehicle VEH (Fuel cell materials) in the centrifugal mixer (Thinky corp. Inc, ARE 310), the powder to ink vehicle ratio=1:1 wt/wt. The cathode paste was finally screen printed on the electrolyte (active area=16 cm²) and sintered at 1050° C. for 2 h.

TABLE 1

| Compositions | | Vol. % |
|---|---|---|
| NiO—F (3.5 m²/g) | Fuel cell materials | 30.3 |
| 10Sc1CeSZ (11 m²/g) | Terio corporation | 24.7 |
| Corn Starch | (Sigma Aldrich) | 8 |
| Ethanol (99.9%) | Carlo ERBA reagent | 16.6 |
| 2-Butanone | Fluorochem | 8.4 |
| TEA | Chem-Impex | 0.8 |
| | International, Inc. | |
| DBP | J&K Scientific | 2.2 |
| PEG400 | Alfa Aesar | 3 |
| PVB | Sigma | 6 |
| | Electrolyte | AFL |
| Composition | Vol. % | |
| ScCeSZ—TC | 2.37 | 0.95 |
| NiO—F | 0 | 1.24 |
| EtOH | 96.47 | 96.52 |
| TEA | 0.57 | 0.69 |
| DBP | 0.23 | 0.25 |
| PVB | 0.36 | 0.36 |

### Example 2

### Current Collector Preparation

Commercial nickel fiber felt (Magnex co.ltd, Japan), wire thickness=0.05 cm, the diameter of the nickel wire ˜7×10⁻³ cm and areal density ˜0.0865 gm cm⁻² were used for current collector preparation (see FIG. 9a) The Ni-felt was cut into 3.5×3.5 cm², a stock solution of scandium (concentration=93.27 g/L) is prepared by dissolving the Sc₂O₃ (99.9%, Terio corporation) in HNO₃ overnight at 80° C. Stoichiometry amount of scandium solution was then sprayed on the pre-shaped Ni-felt and dried at 40° C. for 2 h (see FIG. 9c) The Crofer 22H grid (thickness=0.23 mm, area=3.5×3.5 cm²) with a mesh opening 0.9×1.5 mm (Fiaxell, Switzerland) are used as cathode current collector, before fitting on the manifold the grid are molded into a V-shape groove (height 0.1 cm) for the gas channel.

### Example 3

### Characterizations and Electrochemical Tests

The cell was tested by the Scribner test station (855 SOFC), at first the ASC is fixed between a pair of Crofer manifolds (5.1×5.1 cm²), two gaskets (Thermiculite 866 Flexitallic, USA) are used for sealing, the anode current collector (Ni or Sc: Ni-mesh) and the cathode current collector are fixed on the specified manifold using Ni-paste and LSM-paste (fuel cell materials), respectively, the Crofer 22APU wire is used as the current lead for both anode and current. The cell with ‘Sc: Ni-felt’ and ‘Ni-felt’ current collector are named as ‘S-cell’ and respectively, in the manuscript. After stacking the cell, ceramic bond (ceramabond 552, Aremco product Inc, USA) is brush coated to seal the manifold. The schematic of the stacking is shown in FIG. 1. The sealed cell setup is then placed in the furnace with a load of 5 psi, the furnace is programmed with ramp 1° C. min⁻¹ up to 800° C. Upon reaching the temperature, the cell is purged with N₂ and air in anode and cathode, respectively, the anode forming is accomplished with a low concentration of dry fuel (10% H₂-90% Ar) 0.20 L to pure hydrogen in the anode while 1 L min⁻¹ air to the cathode. After attaining the OCV of the cell, the temperature of the furnace cooled down to 700° C. and change the fuel to the humidified CH₄. The electrochemical impedance analysis of the cell is performed under a constant load with an RMS amplitude of 10% DC in the frequency range 1 KHz to 0.01 Hz. The I˜V characteristics of the cell are carried out after the EIS test with 0.1 V/point voltage scan. The galvanostatic test carried out under humidified CH₄ with a load of 0.2 A cm⁻² for 1 h. After the electrochemical test, the cell was ramped to cool down to room temperature with purging in Argon. The microstructure and X-ray diffraction analysis of the cell and the current collector are carried out after the electrochemical test

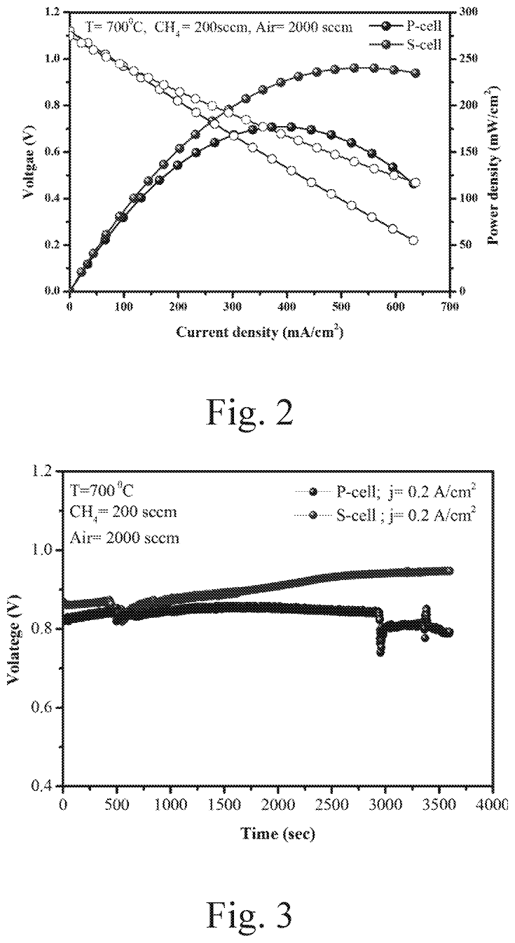

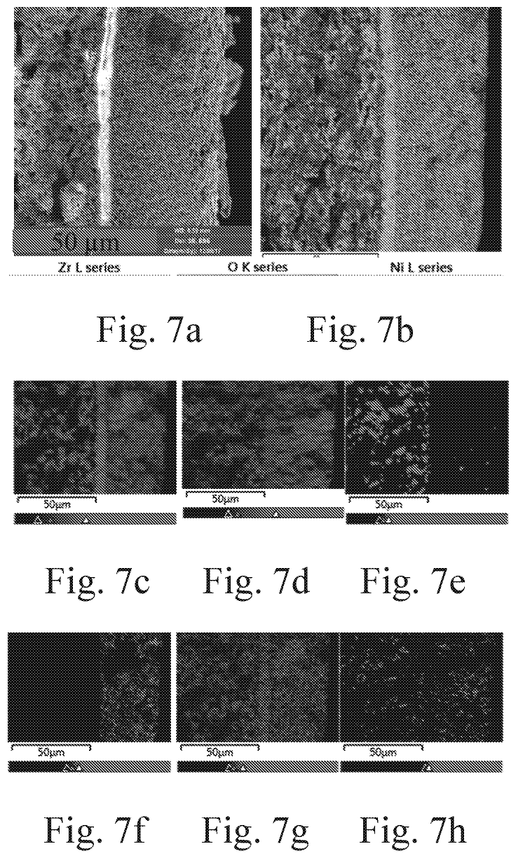

The most common anode supported cell (ASC) configuration for hydrocarbon fuel cells is Ni-ScSCZ//ScSZ//LSM-SCSZ. The microstructure of the cross-section of the anode-supported cell and the corresponding EDX analysis is shown in FIG. 7. The open-circuit voltage of the cells is recorded after reduction NiO to Ni at 800° C. underflow H₂/Ar. The EIS and galvanostatic test were carried out under the flow of humidified methane (H₂O: CH₄=0.03) and dry air. As it is reported that the open circuit condition is a favorable condition for carbon deposition even for the humidified methane fuel so at the zero loads (open circuit) for methane is flown about 60 min. The initial OCV of P-cell and S-cell are 1.11V and 1.09 V, respectively, with flow rates 0.20 L min⁻¹ of humidified CH₄ and 2 L min⁻¹ of air at 700° C., which is closer to the theoretical value of 1.20 V for a the Ni—ScSZ based anode supported cell, this indicts the cell is perfectly sealed without any leakage. The small deviation in the OCV in the cell may be due to the presence of pinhole in the electrolyte microstructure. The typical current-voltage (I-V) and current-power (I-P) characteristics of the cells are shown in FIG. 2 at 700° C. in humidified CH₄. The maximum power density (Pₘₐₓ) of the cells are 177 mW cm⁻² (2.83 W) and 240 m Wcm⁻² (3.84 W) at 0.6V, a significant improvement (˜36%) in the cell performance are recorded for S-cell. The electrochemical performance of S-cell without the use of any precious metal current collector, wire, and paste is very significant, so far no data are reported for similar configuration cell in the literature for comparison.

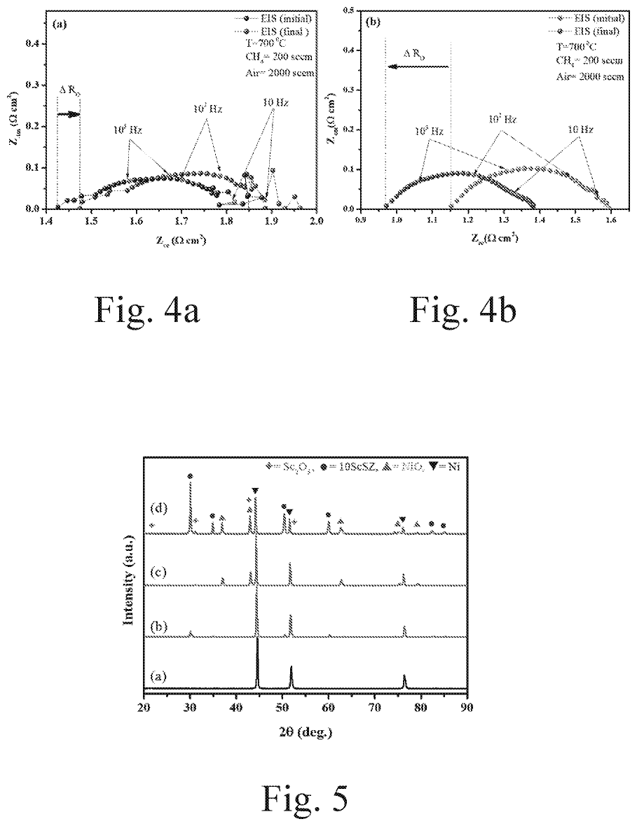

Nevertheless, both cell has identical in configuration, microstructure, and component, so the higher in the cell performance of S-cell mostly attributed to the superior catalytic activity of the Sc: Ni-fiber felt compared to Ni-felt current collector. To confirm the effect of the current collector, the electrochemical impedance of the single cell is measured, due to the limitation of the test station potentiostat and frequency analyzer the impedance spectra of the cell are recorded with a load of 3.2 A (j=200 mAcm⁻²). The Nyquist plot of P-cell and S-cell are shown in FIGS. 4a and 4b, respectively at 700° C. In the impedance spectra the ohmic resistance (Rₒ) is the intercept of the Z-arc at high frequency with Zᵣₑ axis, where the ohmic is the collective resistance of the electrical contact between the anode-current collector, cathode-current collector, and resistance electrolyte. The polarization resistance (Rₚ) of the cell is the chord length of the impedance arc, i.e. the length of Z-arc intercept at the low and high frequency (R_{T}−Rₒ). The Rₚ involve the charge-transfer at the TPB (triple phase boundary) and through the electrolyte, gas diffusion, dissociation/adsorption of H₂, surface diffusion of the adsorbed species to the triple-phase-boundary (TPB), and the gas conversion. Hence the Rₚ of the cell basically depends on the activity of the electrode and electrolyte's microstructure, transports of ion and electrons and catalytic oxidation of the fuel and reduction of the oxygen. However, the main target is to evaluate the effect of the current collector activity on the electrochemical performance of the cell. The total resistance of P-cell and S-cell are 1.86 and 1.598 Ωcm² respectively, which are concurrent with the trends of the cell performance, however, it is interesting to note that the Rₒ (1.43 Ωcm²) of P-cell is larger than the Rₒ (1.115 Ωcm²) of S-cell, while the corresponding Rₚ of P-cell (0.43 Ωcm²) is closer to S-cell (0.45 Ωcm²). These impedance data confirms that both cells have exhibits comparable gas diffusion and mass transport and charge transfer kinetics so the difference in the cell performance vastly due to the activity of the current collector. We defined the R_{O}/R_{T} ratio as ohmic contribution to the cell performance, then the R_{O}/R_{T} ratio of P-cell and S-cell are 76% and 72%, this reveals that a significant effect of the ohmic resistance has found in both the cells, so minimizing the ohmic loss a major tactic to improve the cell efficiency. Furthermore, to evaluate the effect of the Sc: Ni-fiber felt current collector on the stability and degradation of the NiO—ScSZ support cell under humidified CH₄, the galvanostatic test were conducted with a current load of 200 mA/cm² at 700° C. for 1 hr. FIG. 3, represents the galvanostatic test of both P and S-cell under humidified CH₄, it can be observed that the initial voltage of each cell is stable for about 10 min, a fluctuation in the voltage indicates the deposition of the carbonaceous species on the Ni-catalyst surface. The P-cell shows no indication of the degradation due to the coking or deposition of carbon until 50 min then a sudden degradation of the voltage were recorded, while in S-cell the cell voltage was improved with time, without any noticeable fluctuation in the voltage. A clear difference in the cell voltage was observed in both the cells, the voltage loss in P-cell is about 3.65% while a significant improvement (gain) in the voltage (9.48%) is obtained in the S-cell. To further confirm the potentiostatic EIS test was conducted on the cell after the galvanostatic test with a load of 200 mA cm⁻², the corresponding Nyquist plot of P and S-cell were shown in FIGS. 4a and 4b, respectively. It is observed that in the P-cell both the R_{O} and the Rₚ were increased while in the S-cell surprising the Rₒ and Rₚ were decreased. Table 2 shows the Rₒ, R_{T}, and Rₚ of P and S-cell before and after the galvanostatic test at 700° C. under humidified CH₄. This EIS data followed by the galavanostatic test indicates that the Sc: Ni-felt has significant catalytic activity on the methane oxidation which enhances the cell performance and durability. The schematic diagram shown the expected partial oxidation process of the methane in presence of the H₂O on the Sc:Ni-felt surface where the oxidation reaction resulting the production of the H₂ which thus goes towards the cermet anode for anodic reaction while deposition of the carbon on the fiber surface enhances the conductivity of the current collector and the byproducts CO and CO₂ are leaving from the anode sites. To prove our hypothesis at first we characterized the phase and microstructure of both Ni-felt and Sc: Ni-felt and the anode surface after the electrochemical test.

TABLE 2

| | P-cell | | | S-cell | | |
|---|---|---|---|---|---|---|
| 700° C. | Rₒ | R_{T} | Rₚ | Rₒ | R_{T} | Rₚ |

Ω cm²

| | | | | | | |
|---|---|---|---|---|---|---|
| Initial | 1.43 | 1.86 | 0.43 | 1.15 | 1.59 | 0.44 |
| Final | 1.49 | 1.96 | 0.47 | 0.97 | 1.38 | 0.41 |

The XRD analysis of the felt and anode surface of S-cell and P-cells are shown in FIG. 5. The XRD patterns of the felt and the anode surfaces were matched with the ICDD files. A pure cubic phase of ‘Ni’ is detected in the current collector of the P-cell, while the anode surface is matched with NiO, Ni and 10-ScSZ. The XRD pattern of the S-cell anode surface is matched with pure NiO, Ni and 10ScSZ, while the current collector is composed of NiO, Ni and Sc₂O₃ phases this may be due to oxidation of the felt during the cooling of the cell. No traces carbon impurity or chemical transformation of the felt are detected by XRD analysis in both the cells.

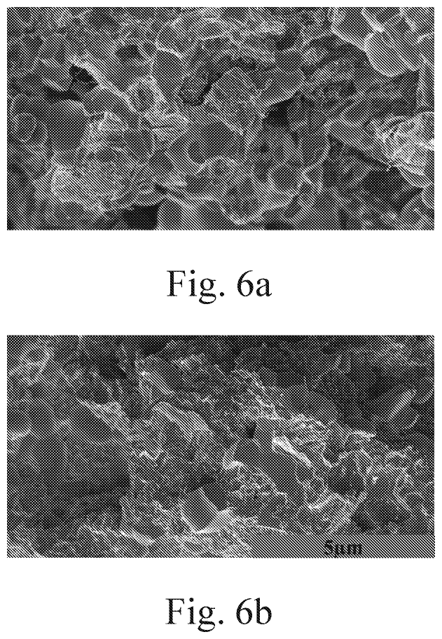

Furthermore, the microstructure of the cells was investigated, the FESEM analysis of the NiO—ScSZ after the electrochemical tested cell is shown in FIGS. 6a and 6b of P-cell and S-cell, respectively. Clear evidence of the carbon deposition is detected in Ni—ScSZ of the P-cell, a thick film-like carbonaceous fiber is observed in the anode of P-cells. In S-cell no trace of carbon deposition is confirmed by the microstructure analysis, this may be due to the oxidation of the carbon during the cooling process, which previously confirmed by the XRD analysis.

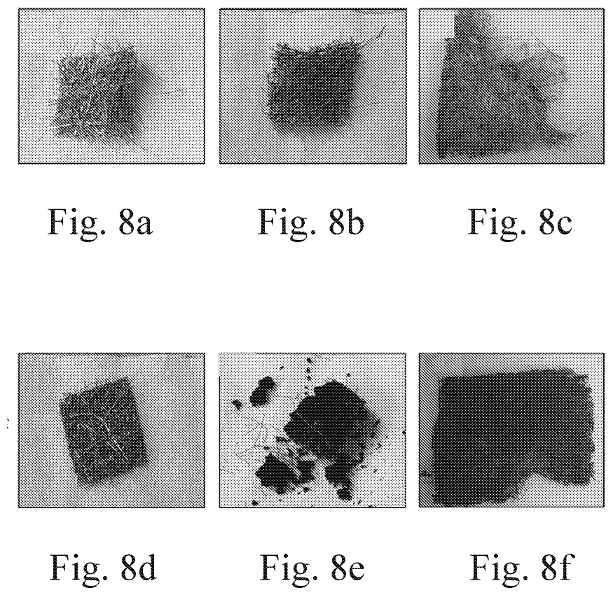

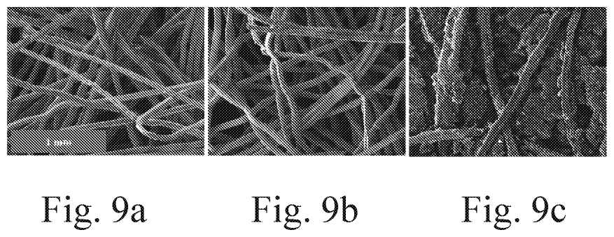

To get the evidence of partial oxidation of methane on the current collector, the methane cracking experiment was carried out in a horizontal quartz tube reactor at 700° C. for 5 h. The Ni-felt and Sc: Ni-felt (Sc=1 wt %) are kept inside the reactor about 0.2 Lmin⁻¹ CH₄ (3% H₂O) are flown, after the methane cracking experiments the reactor are cooled down under purging of Argon. The photographic image of the Ni-felt, Sc: Ni-felt and the corresponding figure after methane exposed is shown in FIGS. 8a to 8f. The microstructure of the Ni-felt, methane exposed Ni-felt and methane exposed Sc: Ni-felt are shown in FIGS. 9a, 9b, and 9c, respectively. Clear evidence of the carbon deposition confirms that the Sc: Ni-felt exhibits superior catalytic activity than the pristine nickel-felt for partial oxidation of the methane. Therefore it is concluded that the use of the Sc: Ni-felt is improving the stability and reliability of the Ni-based cermets support cell and improve the electrochemical efficiency. The low cost, simple processing of the Sc: Ni-felt may be used in large area SOFC for commercialization.

A scandium-modified nickel anode current collector is developed for hydrocarbon fuel SOFC. The electrochemical test in humidified methane under potentiostatic condition reveals that the ohmic and polarization resistance are lessened with cell operation time, while degradation observed in the cell with the pristine nickel current collector. The galvanostatic test confirms that the cell with the modified current collector exhibits better stability. A significant improvement of cell performance (˜36%) is achieved using the scandium modified current collector. The microstructure and phase analysis accomplishes the partial oxidation of methane on the scandium modified nickel current collector is the main advantages on the improvement of the performance and the stability of the state of the art anode supported cell under hydrocarbon fuel.

1.-7. (canceled)

8. A solid oxide fuel cell (SOFC) assembly connectable to a source of a hydrocarbon fuel; said SOFC assembly comprising at least one SOFC; each SOFC further comprising:
a. an anode support member having a nickel felt-made anode current collector;
b. an electrolyte layer disposed on said anode support member;
c. a cathode having a cathode current collector; said cathode disposed on said electrolyte layer;
wherein said nickel-fiber-felt-made anode current collector is doped with Scandium.

9. The SOFC according to claim 8, wherein said cathode, anode and electrolyte are nested within a ceramic bond.

10. The SOFC according to claim 8, wherein said cathode is made of a LSM/ScSZ composite material.

11. The SOFC according to claim 8, wherein said anode support member is made of sintered Ni-ScSZ.

12. The SOFC according to claim 8, wherein said electrolyte layer is a ScSZ paste.

13. The SOFC according to claim 8, wherein said felt-made anode current collector doped with scandium was made by spraying solution of Sc₂O₃ in HNO₃.

14. A method of manufacturing a solid oxide fuel cell; said method comprising steps of:
a. manufacturing an anode support member by sintering NiO and ScSZ;
b. spraying an electrolyte ScSZ layer on said anode support member;
c. sintering said electrolyte ScSZ layer;
d. printing a cathode layer of LSM-ScSZ paste on said electrolyte ScSZ layer;
e. sintering said cathode layer;
f. manufacturing an anode collector;
g. manufacturing a cathode current collector; and
h. connecting said anode and cathode current collectors to said anode and cathode, respectively;
wherein said step of manufacturing said anode current collector comprises providing a nickel-fiber-felt-made member and spraying solution of Sc₂O₃ in HNO₃ onto a nickel felt.
